(19) United States
(12) Patent Application Publication
(10) Pub. No.: US 2006/0223532 A1
(43) Pub. Date: Oct. 5, 2006

(54) Method for user equipment mobility management and communication system

(76) Inventors: Sheng Liu, Shenzhen (CN); Baijun Zhao, Shenzhen (CN)

Correspondence Address: BERENATO, WHITE & STAVISH, LLC, 6550 ROCK SPRING DRIVE, SUITE 240, BETHESDA, MD, 20817, US

(21) Appl. No.: 10/551,426

(22) PCT Filed: Apr. 3, 2003
(86) PCT No.: PCT/CN03/00238

§ 371 Date: Jun. 9, 2006

(51) Int. Cl. H04Q 7/20

(52) U.S. Cl. 455/436

(57) ABSTRACT

The present invention relates to a method of UE mobility management and a mobile communication system of implementing this method, where the system includes: a core network communicating with the universal terrestrial radio access network (UTRAN) via the Iu interface; UTRAN consisting of multiple radio network systems (RNS) and communicating with one or more UE via the Uu interface, and each said RNS comprising a radio network controller (RNC) and one or more nodes communicating with said RNC via the Iub interface, while communication between RNC being performed via the Iur interface; UTRAN controlling UE mobility management through radio resource control (RRC) signalling of the Uu interface; and said method includes: UE transmitting uplink RRC signalling information to a first RNC to request UE mobility management; the first RNC receiving and forwarding said uplink RRC signalling information to the core network; the core network forwarding transparently said uplink RRC signalling information to a second RNC; and the second RNC receiving and utilizing said uplink RRC signalling information to perform the required mobility management.

### FIELD OF THE INVENTION

The present invention relates to a method for user equipment (UE) mobility management in a mobile communication system. More particularly, the present invention relates to a method for cell update and user registration area (URA) update when there is no Iur signalling link between a serving radio network controller (RNC) and a destination RNC in a WCDMA communication system, and a communication system for implementing this method.

### BACKGROUND ART

In the WCDMA system of the 3rd Generation Partnership Project (3GPP), when the UE is in a radio resource control (RRC) connection mode, four possible states of the RRC layer are introduced: Cell_DCH, Cell_FACH, Cell_PCH, and URA_PCH. In order to support the UE mobility management in Cell_FACH, Cell_PCH and URA_PCH states in the UMTS terrestrial radio access network (UTRAN), the cell update process and the URA (UTRAN Routing Area or User Register Area) update process are defined.

In the network system architecture of the universal mobile telecommunication system (UMTS) as shown in FIG. 1, the core network (CN) is connected to the UTRAN via an Iu interface, and the UTRAN is connected to the UE via an Uu interface (i.e., air interface). The protocol layer having the control function in the Uu interface is RRC layer. The protocol documents such as TS25.311 or the like can be consulted for the detailed descriptions on the RRC protocol.

FIG. 2 further shows a network architecture of the UTRAN, wherein the UTRAN consists of radio network subsystems (RNS) which are respectively connected to the core network via the Iu interface, the different RNSs being connected with each other via the Iur interface. In an RNS, one radio network controller (RNC) is connected to one or more Node B via the Iub interface, and the Node B actually performs the functions of the base transceiver station (BTS) generally used in a mobile communication system. A Node B contains one or more cells, and the cell is a basic unit accessed by the UE. Iu, Iur, Iub and other interface protocols are all divided into a control plane and a user plane, wherein the wireless protocols of a control plane application layer are RANAP (radio access network application part), RNSAP (radio network subsystem application part) and NBAP (Node B application part), respectively. For the detailed descriptions associated with these protocols, TS25.4xx serial protocol documents of the 3GPP can be consulted.

FIG. 3 shows two cases of the connection between the UE and the UTRAN. One case is that one or more cells communicating with the UE are controlled by a radio network controller (RNC), as shown in FIG. 3(a); the other case is that at least one cell communicating with the UE is controlled by the other RNC (called a destination RNC, i.e., DRNC), while a serving RNC (SRNC) may contain or may not contain the cell communicating with the UE, as shown in FIG. 3(b). In the latter case, the DRNC mainly provides radio links, while the upper protocol of the user plane associated with the UE is mainly performed by the SRNC, and additionally, the UE associated communication with the core network is still performed via the Iu interface between the SRNC and the core network.

In the UTRAN of the WCDMA, the UE is in an idle mode after being powered on and resided in a cell, and the UE in the meanwhile may receive system information and cell broadcast messages and monitor the paging from the core network. When the UE responds to the paging or initially issues a call, the UE must set up RRC connection with the UTRAN through a series of signalling processes and enter into the RRC connection mode. TR25.931, TS25.331 and other protocols of the 3GPP can be consulted for the specific signalling processes of the RRC connection setup. When the UE is in the RRC connection mode, the RRC layer totally has four possible states: Cell_DCH, Cell_FACH, Cell_PCH, and URA_PCH. The mobility management process associated with Cell_DCH state is handover, the mobility management process associated with Cell_FACH state and Cell-PCH state is cell update, and the mobility management process associated with URA_PCH state is URA update.

In Cell_DCH state, the UE has a dedicated physical channel (corresponding to one or more dedicated transport channels DCHs), and the cell having a physical link with the UE becomes an active cell, and all the active cells constitute an active set of the UE, and when the number of the active sets is equal to or greater than 2, the RNC will be responsible for the micro diversity combination of the uplink and the allocation of the downlink. In this state, the Iur user plane interface between the SRNC and the DRNC has an active DCH data frame link for transmitting DCH data frames.

In Cell_FACH state, the system does not allocate any dedicated physical channel to the UE. However, the UE may use a common (transport) channel—random access channel (RACH (uplink)) and forward access channel (FACH (downlink))—to transmit user data with low activeness. In this state, the Iur user plane interface has an active common transport channel (CCCH) data frame link for transmitting data frames of the common transport channel. In this state, the UTRAN performs the UE mobility management through the cell update process.

In Cell_PCH state, the system does not allocate any active physical channel to the UE. Meanwhile, the UTRAN performs the UE mobility management through the cell update process so as to obtain the location information of the UE on the cell-level, and the UE may receive the system paging by monitoring the PCH. In this state, the Iur user plane interface is usually allocated with a non-active common transport channel data frame link, which can accelerates the handover process of the UE from Cell_PCH state to Cell_FACH state.

In URA_PCH state, the system does not allocate any active physical channel to the UE. Meanwhile, the UTRAN performs the UE mobility management through the URA update process so as to obtain the location information of the UE on the URA-level, and the UE can receive the system paging by monitoring the PCH. In this state, the Iur user plane interface is usually not allocated with any common transport channel data frame link.

For the detailed descriptions relevant to the RRC connection states, TS25.331 and other protocols of the 3GPP can be further consulted; and for the detailed descriptions relevant to the protocols of the data frame on the Iur user plane interface, TS25.425, TS25.427 and other protocols of the 3GPP can be further consulted.

The other UTRAN mobility management process relating to the present invention is SRNS relocation. FIG. 4 is a schematic view showing the SRNS relocation process. FIG. 4a shows the network status of SRNS before relocation, and FIG. 4b shows of the network status in which the DRNC is relocated to the current new SRNC. The SRNS relocation process relates to both the core network and the UTRAN, because it not only changes the Iu interface but also changes the SRNC, and with regard to the UTRAN, the SRNS relocation process performs the handover of the upper protocol entity of the user plane associated with the UE from the original SRNC to a new SRNC (i.e., the original DRNC), without changing the existing radio resources associated with the UE. In the UTRAN, the SRNS relocation process is performed by both the SRNC and the DRNC, and the determination on whether to perform the SRNS relocation process is performed by the SRNC, and it is also the SRNC which initiates the SRNS relocation process. For the detailed SRNS relocation signalling process, TS23.060, TR25.931 and other documents of the 3GPP can be consulted.

In the WCDMA of Release 99, the cell update process and the URA update process both need an RNSAP (radio network subsystem application part) signalling of the Iur interface control plane. However, in the practical UTRAN networking, there may exist no Iur link between some RNCs, and for example, the link between the RNCs overload or there is no Iur link on topologic structure; in addition, even if the Iur physical link exists, the RNSAP signalling link of the Iur interface control plane are caused to be invalid for some abnormal situations. Thus, when the UE moves to a resident cell, and there does not exist available Iur signalling link between the RNC to which the cell belongs and the SRNC of the UE, the cell update process or the URA update process will fail.

### SUMMARY OF THE INVENTION

The present invention presents a set of effective solutions, in light of how to perform cell update and URA update across the RNCs when there is no Iur signalling link between the SRNC and the destination RNC.

According to one aspect of the present invention, a method for user equipments (UEs) mobility management in a mobile communication system is provided, wherein said mobile communication system comprises: a core network, one or more universal terrestrial radio access networks (UTRANs) and a plurality of user equipments (UEs), wherein the core network communicates with the UTRAN via an Iu interface; said UTRAN consists of a plurality of radio network systems (RNSs) and communicates with one or more UEs via a Uu interface, each said RNS comprising a radio network controller (RNC) and one or more nodes communicating with said RNC through an Iub interface, each node comprising one or more cells, and the communication between RNCs being performed via an Iur interface; the UTRAN controls the UE mobility management through a radio resource control (RRC) signalling of the Uu interface; said method comprising the steps of: the UE transmitting uplink an RRC signalling message to a first RNC so as to request UE mobility management; said first RNC receiving and forwarding to the core network said uplink RRC signalling message; the core network forwarding transparently to a second RNC said uplink RRC signalling message; and the second RNC receiving and utilizing the forwarded uplink RRC signalling message to perform the requested mobility management.

According to another aspect of the present invention, a mobile communication system for user equipments (UE) mobility management is provided, wherein said mobile communication system comprises: a core network, one ore more universal terrestrial radio access networks (UTRAN) and a plurality of user equipments (UE), wherein the core network communicates with the UTRAN via an Iu interface; said UTRAN consists of a plurality of radio network systems (RNS) and communicates with one or more UEs via a Uu interface, each said RNS comprising a radio network controller (RNC) and one or more nodes communicating with said RNC through an Iub interface, each node comprising one or more cells, and the communication between RNCs being performed via an Iur interface; the UTRAN controls the UE mobility management through a radio resource control (RNC) signalling of the Uu interface; and wherein the UE comprises means for transmitting uplink the RRC signalling message to a first RNC so as to request the UE mobility management; said first RNC comprises means for receiving from the UE and forwarding to the core network said uplink RRC signalling message; the core network comprises means for forwarding transparently to a second RNC said uplink RRC signalling message; and the second RNC comprises means for receiving and utilizing the forwarded uplink RRC signalling message to perform the requested mobility management.

According to the method of the present invention, when the UE moves to a certain resident cell and it is necessary to perform cell update or URA update, and when there is no available Iur signalling link between the RNC to which the resident cell belongs and the SRNC of the UE, the UE mobility management of the corresponding cell update or URA routing area update can be performed according to the method of the present invention. Two aspects of beneficial effects can be obtained by using the present invention: one aspect is that by adopting the present invention in the practical networking, the cell update and URA update processes across the RNCs can be realized when the Iur link does not exist for the cost and geographical environment reasons and the like, the other aspect is that even if the Iur link exists, better system reliability can still be obtained by using the present invention, and concretely speaking, when the Iur link overloads or fails, the original Iur link can be replaced by using the present invention to realize the cell update and URA update processes, thereby to improve the system reliability.

### BRIEF DESCRIPTION OF THE DRAWINGS

Referring to the following accompanying drawings, the embodiments of the present invention are explained, wherein:

FIG. 1 is a schematic view of UMTS network system architecture;

FIG. 2 is a schematic view of network architecture of the UTRAN in the UMTS network system architecture;

FIGS. 3(a) and 3(b) schematically show two cases of the connection between the UE and the UTRAN;

FIGS. 4 (a) and 4(b) are schematic views showing the SRNS relocation process in the UMTS network system architecture;

FIG. 5 shows a signalling process of the cell update in combination with the SRNS relocation;

FIG. 6 shows a signalling process of the URA update in combination with the SRNS relocation;

FIG. 7 shows a signalling process of the cell update using a data frame link of a common transport channel of the Iur user plane;

FIG. 8 shows a signalling process of the URA update using a signalling link of the Iur control plane;

FIG. 9 shows a signalling process of the SRNS relocation in the UMTS network system architecture;

FIG. 10 shows a signalling process of a new added RANAP message “Forwarding Uplink RRC Signalling”, according to the present invention;

FIG. 11 is a schematic view showing a process of the cell update method across the RNCs when the Iur signalling link does not exist, according to the present invention; and

FIG. 12 is a schematic view of a process of the URA update method across the RNCs when the Iur signalling link does not exist, according to the present invention.

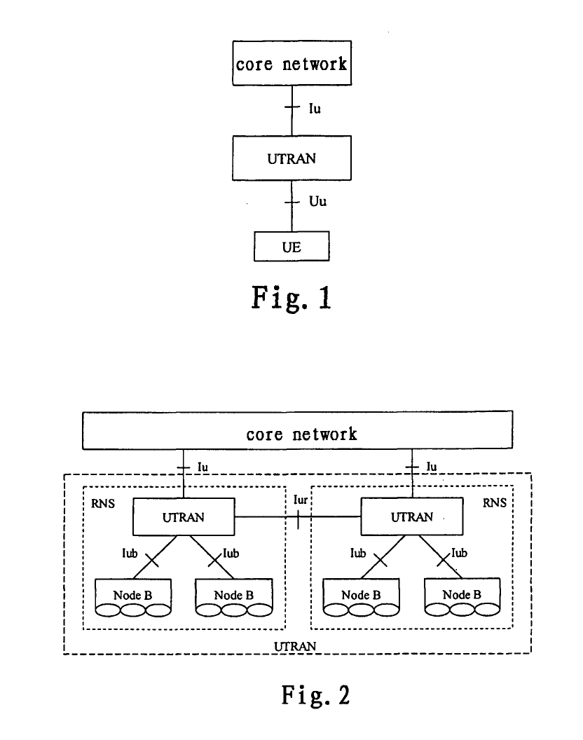

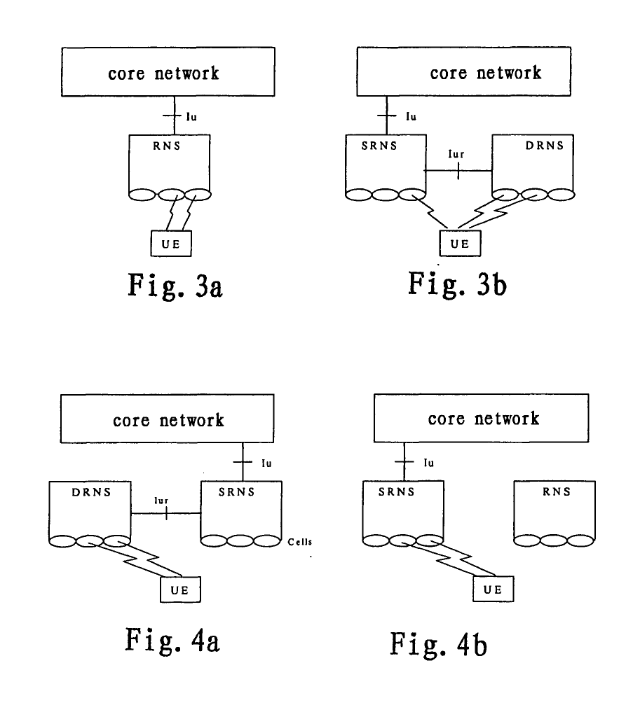

### DETAILED DESCRIPTION OF PREFERRED EMBODIMENTS

In order to more clearly illustrate the present invention, the present invention takes the WCDMA communication system as an example in the preferred embodiments. However, the present invention is not limited to the above system, and other communication systems which have the similar structure and functions can also realize the mobility management by using the present invention. It can be similarly understood that, based on the present invention, a person skilled in the art can easily make various improvements, modifications and transformations, which should be considered to be not depart from the principles of the present invention.

Referring to the accompanying drawings, the present invention is further described in detail as follows:

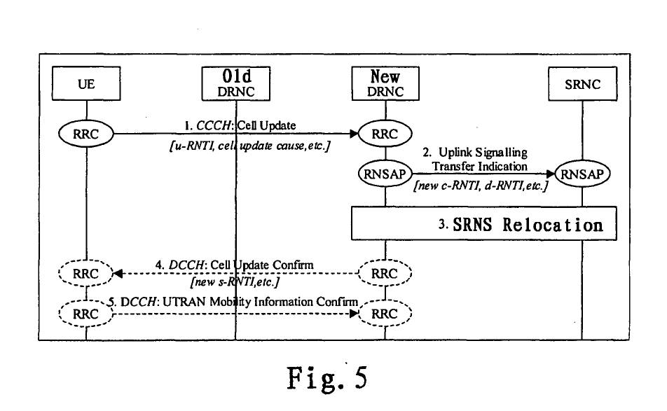

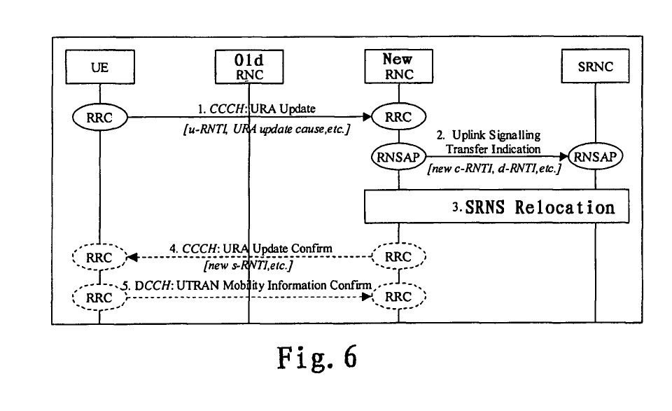

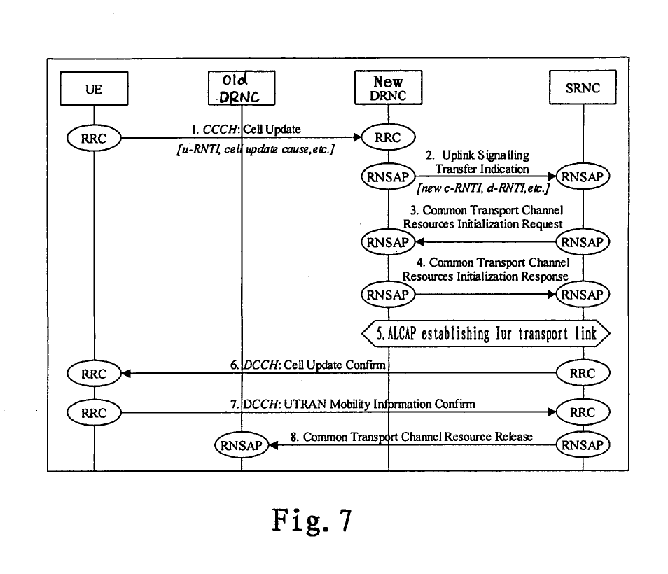

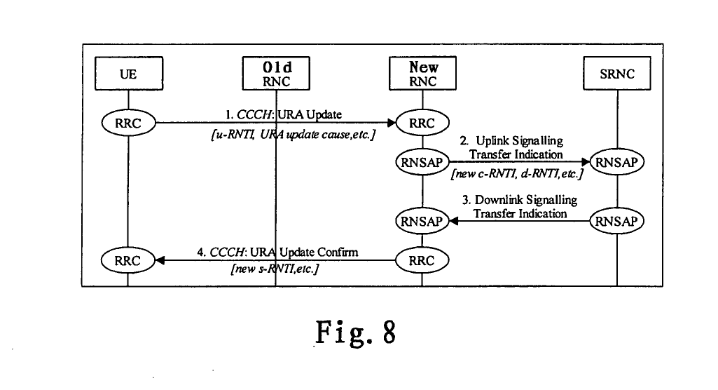

In the prior art, the cell update process across the RNCs can be realized mainly using two kind of methods: (1) the cell update process using SRNS relocation, and (2) the cell update process using a data frame link of a common transport channel of the Iur user plane. FIG. 5 shows a typical signalling process of the cell update in combination with the SRNS relocation, and FIG. 7 shows a typical signalling process of the cell update using a data frame link of the common transport channel of the Iur user plane. For the detailed description of these signalling processes, TR25.931 and other protocols can be consulted.

Similarly, the URA update process across the RNCs can be realized using two kinds of methods: (1) the URA update process using SRNS relocation, and (2) the URA update process using a signalling link of the Iur control plane. FIG. 6 shows a typical signalling process of the URA update in combination with the SRNS, and FIG. 8 shows a typical signalling process of the URA update using a signalling link of the Iur control plane. For the detailed description of these signalling processes, TR25.931 and other protocols can be consulted.

During the establishment of the RRC connection, the RRC performs the estimating, determining and executing functions, such as handover, preparation for handover, cell reselection or cell update, based on the measurement result of the UE. The UE in the states of CELL_FACH, CELL_PCH or URA_PCH can request a cell update process, and the main purpose of the cell update process is to update the UTRAN into the current cell of the UE after the UE completes the cell reselection.

Referring to FIG. 5, it shows the signalling process of the cell update in combination with SRNS relocation. The cell update process using the SRNS relocation mainly involves:

1. the UE transmitting RRC message—“Cell Update Message” which a Common Control Channel (CCCH) bears, to the RNC to which the current resident cell of the UE belongs (namely, a new DRNC), this RRC message comprising an information element u-RNTI (UTRAN radio network Temporary Identifier), Cell Update Cause and other information;

2. after receiving the RRC message, a new DRNC transmitting RNSAP message—“Uplink Signalling Transfer Indication” to the SRNC, this RNSAP message comprising new c-RNTI and d-RNTI and other information elements, wherein c-RNTI is a radio network temporary identifier for controlling the cell, while d-RNTI is a radio network temporary identifier of the destination RNC;

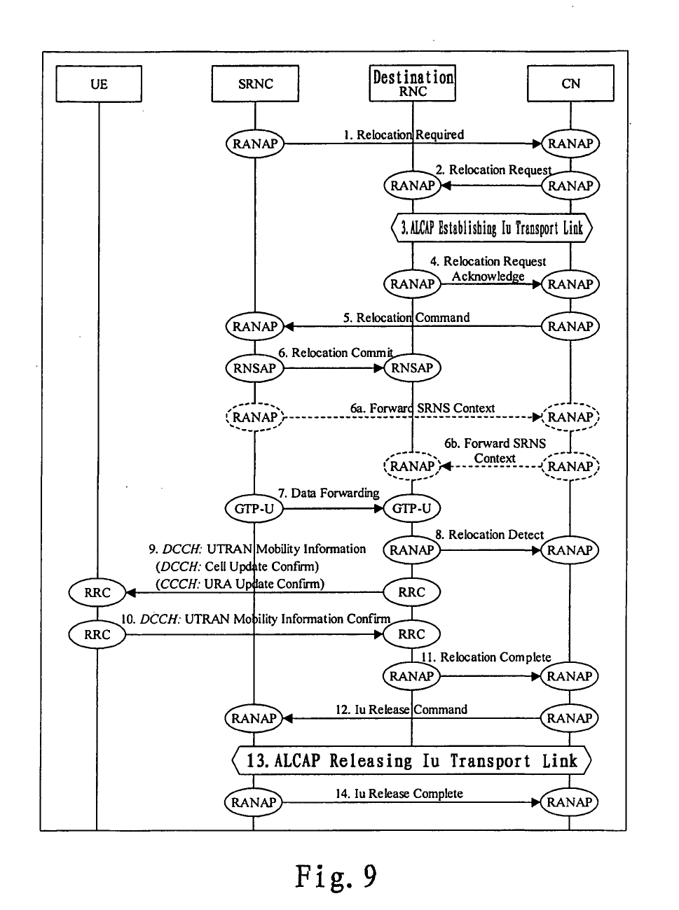

3. after receiving the RNSAP message, the SRNC reporting to the CN through the upper protocol and completes the SRNS relocation. The specific process of the SRNS relocation will be described in detail in the following part by referring to FIG. 9;

4. after relocation (namely, becoming a new SRNC), the new DRNC transmitting to the UE the RRC message—“Cell Update Confirm”, which the dedicated control channel (DCCH) bears, this RRC message comprising a new s-RNTI information element, namely, a radio network temporary identifier of the new SRNC;

5. upon receiving the RRC message “Cell Update Confirm” transmitted by the new DRNC, the UE transmitting to the new DRNC the RRC message—“UTRAN Mobility Information Confirm”, which the DCCH bears so as to confirm the updated relevant information.

FIG. 6 shows a signalling process of the URA update using SRNS relocation, which mainly involves:

1. the UE transmitting the RRC message—“URA Update Message” which the Common Control Channel (CCCH) bears, to the RNC to which the current resident cell of the UE belongs (namely, a new RNC), this message comprising an information element u-RNTI (UTRAN radio network Temporary Identifier), URA Update Cause and other information;

2. after receiving the RRC message, the new RNC transmitting the RNSAP message—“Uplink Signalling Transfer Indication” to the SRNC, this RNSAP message comprising new c-RNTI and d-RNTI and other information, wherein c-RNTI is a radio network temporary identifier for controlling the cell, while d-RNTI is a radio network temporary identifier of the destination RNC;

3. after receiving the RNSAP message, the SRNC reporting to the CN through the upper protocol and completes the SRNS relocation. The specific process of the SRNS relocation will be described in detail in the following part by referring to FIG. 9;

4. after relocation, the new RNC transmitting to the UE the RRC message—“URA Update Confirm”, which the CCCH bears, this message comprising a new s-RNTI information element, namely, a radio network temporary identifier of the new SRNC;

5. upon receiving the RRC message “URA Update Confirm” transmitted from the new RNC, the UE transmitting to the new DRNC the RRC message—“UTRAN Mobility Information Confirm”, which the DCCH bears, so as to confirm the updated relevant information.

In FIGS. 5 and 6, the signallings indicated by dotted lines, i.e., signalling steps 4 and 5 shown in FIGS. 5 and 6, are actually contained in the SRNS relocation process, as described below. However, steps 4 and 5 are separately drawn for the purpose of showing the difference in the SRNS relocation process between the cell update and the URA update.

FIGS. 7 and 8 are referred to in the following descriptions, wherein FIG. 7 shows the cell update process using a data frame link of the Iur user plane, which involves the following steps:

1. the UE transmitting the RRC message—“Cell Update Message” which the Common Control Channel (CCCH) bears, to the RNC to which the current resident cell of the UE belongs (namely, a new DRNC), this message comprising an information element u-RNTI (UTRAN radio network Temporary Identifier), Cell Update Cause and other information;

2. after receiving the RRC information, the new DRNC transmitting to the SRNC the RNSAP message—“Uplink Signalling Transfer Indication”, this RNSAP message comprising new c-RNTI and d-RNTI and other information elements, wherein c-RNTI is a radio network temporary identifier for controlling the cell, while d-RNTI is a radio network temporary identifier of the destination RNC;

3. after receiving the RNSAP message, the SRNC transmitting the RNSAP message—“Common Transport Channel Resources Initialization Request” to the new DRNC via the Iur interface between the SRNC and the new DRNC;

4. Responsive to the above RNSAP message, the new DRNC transmitting an RNSAP message—“Common Transport Channel Resources Initialization Response” to the SRNC;

5. afterwards, establishing the Iur transport link through the access link control application part (ALCAP) between the new DRNC and SRNC;

6. after establishing the Iur transport link using the ALCAP, the SRNC transmitting to the UE the RRC message—“Cell Update Confirm”, which the DCCH bears;

7. upon receiving the RRC information—“Cell Update Confirm” transmitted from the new SRNC, the UE transmitting to the SRNC the RRC message—“UTRAN Mobility Information Confirm” which the DCCH bears, so as to confirm the updated relevant information; and

8. the SRNC confirming the RRC information and transmitting to the old DRNC the RNSAP message—“Common Transport Channel Resources Release” so as to release the Iur link resources of the common transport channel.

FIG. 8 is the URA update process using a signalling link of the Iur control plane, which involves the following steps:

1. the UE transmitting the RRC message—“URA Update Information” which the Common Control Channel (CCCH) bears, to the RNC to which the current resident cell of the UE belongs (namely, a new RNC), this message comprising an information element u-RNTI (UTRAN radio network Temporary Identifier), URA update cause and other information;

2. after receiving the RRC information, the new RNC transmitting the RNSAP message—“Uplink Signalling Transfer Indication” to the SRNC, this RNSAP message comprising new c-RNTI and d-RNTI and other information elements, wherein c-RNTI is a radio network temporary identifier for controlling the cell, while d-RNTI is a radio network temporary identifier of the destination RNC;

3. after receiving the RNSAP message, the SRNC transmitting the RNSAP message—“Downlink Signalling Transfer Indication” to the new RNC; and

4. after receiving the RNSAP message, the new RNC transmitting to the UE the RRC message—“URA Update Confirm”, which the CCCH bears, this message comprising a new s-RNTI information element, namely, a radio network temporary identifier of the new RNC.

The cell update process using the SRNS relocation is quite similar to the URA update process. As to the cell update process using a data frame link of the common transport channel of the Iur user plane, it mainly has two characteristics: one is establishing a data frame link of the common transport channel of the Iur user plane, by using the RNSAP and ALCAP (access link control application part) and other signalling of the Iur interface control plane, and the other is the RRC message associated with cell update between the SRNC and the UE being transmitted to a new DRNC (generally called a destination DNC) afterwards, by using the established data frame link of the common transport channel of the Iur user plane. Different from the above, in the URA update process using a signalling link of the Iur user plane, the data frame link of the common transport channel of the Iur user plane is not established, while the RRC message—“URA Update Confirm” transmitted from the SRNC to the UE is transmitted to the new RNC (generally called a destination RNC) using the signalling link of the Iur control plane. However, no matter which method is used, the cell update process and the URA update process both at least need to use the signalling link of the Iur interface between the SRNC and the destination RNC.

As aforesaid, due to the topologic structure of the UTRAN and other reasons, the cell update and URA update cannot be realized across the RNCs by using the prior art, in the case where there is no Iur signalling link between the SRNC and the destination RNC.

On the other hand, the applicant notices that, the cell update and URA update processes using SRNS relocation can avoid the establishment and use of the signalling link of the Iur user plane in the prior art. In addition, the following analysis shows that the prior art also supports the SRNS relocation process without using the signalling link of the Iur control plane. FIG. 9 shows the signalling process of the SRNS relocation, and TS23.060, TS25.323, TR25.931 and other protocols of the 3GPP can be consulted for the detailed descriptions on this process.

FIG. 9 schematically shows the signalling process of the SRNS relocation, wherein,

1. the SRNC transmitting to the CN the RANAP message—“relocation Required” message;

2. Responsive to the above RANAP message, the CN transmitting to the destination RNC the RANAP message—“Relocation Request” message;

3. As to the relocation request message, the ALCAP signalling establishing the Iu transport link between the destination RNC and the CN;

4. the destination RNC acknowledging the relocation request and transmitting to the CN the RANAP message—“Relocation Request Acknowledge”;

5. according to the acknowledgement, the CN transmitting to the SRNC the RNSAP message—“Relocation Command”;

6. upon receiving the relocation command, the SRNC transmitting to the destination RNC the RNSAP message—“Relocation Commit”;

7. through the GPRS tunnel protocol user plane (GTP-U) signalling, the SRNC transmitting to the destination RNC the “Data Forwarding” message;

8. subsequently, the destination RNC transmitting to the CN the RANAP message—“Relocation Detect”;

9. the destination RNC transmitting simultaneously to the UE the RRC message—“UTRAN Mobility information”, or “Cell Update Confirm” or “URA Update Confirm”, which the DCCH bears;

10. the UE acknowledging the above message and transmitting to the destination RNC the corresponding RRC message which the DCCH bears;

11. the destination RNC transmitting to the CN the RANAP message—“Relocation Complete”;

12. afterwards, the CN transmitting to the SRNC the RANAP message—“Iu Release Command”;

13. the ALCAP releasing the Iu transport link; and

14. the SRNC transmitting to the CN the RANAP message—“Iu release complete” and reporting to the CN the Iu release completion.

It needs to be explained that, signalling step 9 shown FIG. 9 may use three different RRC messages: given a separate SRNS relocation process, “UTRAN mobility information” will be used; given the SRNS relocation process resulting from the cell update, “Cell Update Confirm” will be used; and given the SRNS relocation process resulting from the URA update, “URA Update Confirm” will be used.

As shown in FIG. 9, the SRNS relocation process begins with the transmission of the RANAP message “Relocation Required” by the SRNC to the CN, and when the CN sends to the SRNC the RANAP message “Relocation Command”, the transport link of the Iu user plane between the CN and the destination RNC has been established, which prepares well for the relocation. The handover from the SRNC to the destination RNC begins with the transmission of the RNSAP message “Relocation Commit” from the SRNC to the destination RNC, and this message carries all the SRNS Contexts associated with the UE in the SRNC, and the destination RNC can seamlessly re-establish the communication with the UE by means of this message. When there is no Iur signalling link between the SRNC and the destination RNC, the RNSAP message “Relocation Commit” (i.e., step 6) can be replaced by the RANAP message “Forward SRNS Context” (i.e., steps 6a and 6b) indicated by dotted lines in FIG. 9 to perform the same functions. Here, the function of the CN is actually to route all the “SRNS Contexts” associated with the UE from the SRNC to the destination RNC via the Iu interface, so as to replace the routing via the Iur interface during the use of the RNSAP message “Relocation Commit”.

Thus, in the whole cell update or URA update process, provided that the SRNS relocation with the SRNS context being transmitted using the RANAP message “Forward SRNS Context” (hereinafter briefly called the “SRNS relocation without using Iur interface”) is adopted, then the problem of performing the cell update and URA update across RNCs when there is no Iur signalling link between the SRNC and the destination RNC can be solved, so long as the relevant information carried by the RRC message “Cell Update” or “URA Update” message sent by the UE to the destination RNC can be transmitted to the SRNC without using the signalling link of the Iur. Accordingly, the present invention proposes an effective solution for solving this problem based on the above idea.

First of all, the present invention proposes addition of a new RANAP message—“Forward Uplink RRC Signalling” message, and by means of this message, the CN can route the up-RRC message received by the destination RNC on a logic channel CCCH (common control channel) to the SRNC via the signalling link of the Iu interface so as to replace the routing via the signalling link of the Iur interface during the use of the RNSAP message “Uplink Signalling Transfer Indication”.

The new added RANAP message is borne by the non-connected signalling link of the Iu control plane, and it not only can be sent from the RNC to the CN, namely, the destination RNC directly transmitting the uplink RRC message received by the destination RNC on the logic channel CCCH to the CN, but also it can be sent from the CN to the RNC, namely, the CN forwarding transparently this message to the SRNC. The new added RANAP message contains at least the following four Information Elements (i.e., IE): Message Type, Source ID, Target ID and RRC information, wherein, the information elements “Message Type”, “Source ID” and “Target ID” continue to use the IE having been defined in TS25.413 protocol of the 3GPP: “Message Type” must be contained in each RANAP message for identifying each message itself, “Source ID” is for identifying the SRNC, and “Target ID” is for identifying the destination RNC, and their specific definitions can be found in TS25.413 protocol. The information element “RRC Information” is newly defined here, which is octet strings having variable lengths, namely, the uplink RRC message received by the destination RNC on the logic channel CCCH and to be forwarded to the SRNC.

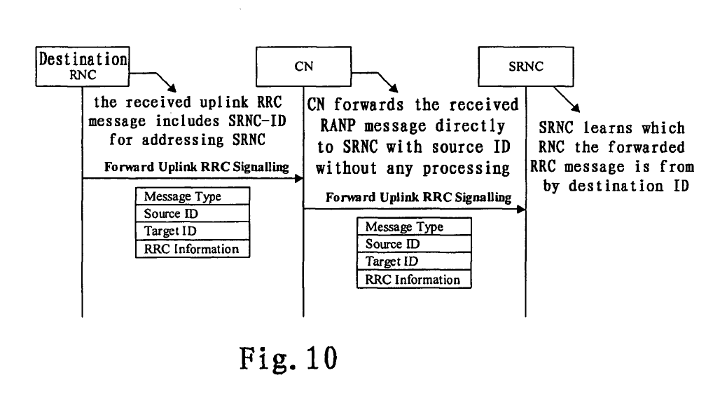

FIG. 10 shows the signalling process of the new added RANAP message “Forward Uplink RRC Signalling”. The uplink RRC message received by the destination RNC from the UE and borne on the CCCH always contains SRNC-ID (Identifier of the SRNC) which is used as the information element “Source ID” of the message “Forward Uplink RRC Signalling” for addressing the SRNC. After receiving this message, the CN, by using the information element “Source ID” carried by this message, forwards the received RANAP message directly to the SRNC without any processing. The SRNC receives the message “Forward Uplink RRC Signalling” sent from the CN and uses the information element “Target ID” carried by this message to learn which RNC the carried RRC information is from.

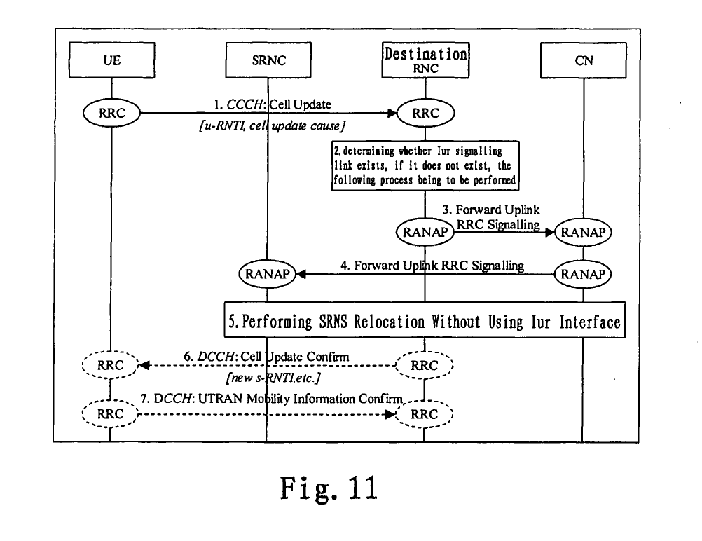

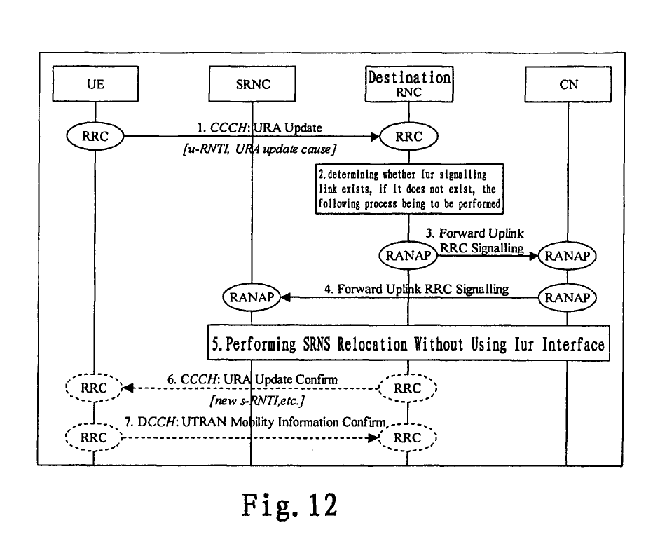

By using the new added RANAP message, the present invention sets forth a method for performing the cell update and URA update across the RNCs when there is no Iur signalling link between the SRNC and the destination RNC, as respectively shown in FIGS. 11 and 12. Taking the cell update process for an example, the method of the present invention is further explained as follows:

1. the UE transmitting the RRC message—“Cell Update”, which the CCCH bears, to the RNC to which the current resident cell belongs, i.e., the destination RNC, this message comprising an information element u-RNTI (UTRAN Radio Network Temporary Identifier), Cell Update Cause and the like. This IE consists of the SRNC identifier SRNC-ID and the UE identifier s-RNTI (Serving Radio Network Temporary Identifier) allocated by the SRNC;

2. after receiving the RRC message, the destination RNC determining whether the Iur signalling link exists, wherein if exists, the cell update process will be performed with the signalling mode shown in FIG. 5 or 7 according to the prior art; otherwise, the following process will be preformed;

3. the destination RNC transmitting to the CN the RANAP message “Forward Uplink RRC Signalling”, wherein the SRNC-ID constitutes the information element “Source ID”, the known identifier of the destination RNC constitutes the information element “Target ID”, and the whole received RRC message “Cell Update” directly serves as the information element “RRC Information”;

4. after receiving the RANAP message “Forward Uplink RRC Signalling” sent from the destination RNC, the CN, by using the information element “Source ID” carried by the above message, forwarding the received RANAP message directly to the SRNC without any processing;

5. after receiving the RANAP message “Forward Uplink RRC Signalling” sent from the CN, the SRNC extracting the RRC message “Cell Update” from the information element “RRC Information” and initiating the SRNS relocation process without using Iur interface by using the destination RNC indicated by the information element “Target ID”, namely, the SRNS relocation process for transmitting the SRNS context by using the RANAP message “Forward SRNS Context”;

6. wherein, when the SRNS relocation process reaches step 9 as shown in FIG. 9, the “SRNS Context” and the upper protocol entity of the UE have been switched to the destination RNC, and the destination RNC has become a new SRNC which consequently can send to the UE the RRC message “Cell Update Confirm” which the DCCH bears, this message containing the SRNC-ID of the destination RNC, i.e., the new SRNC, and the s-RNTI newly allocated by the new SRNC to the UE; and

7. after receiving the RRC message “Cell Update Confirm” sent by the new SRNC, the UE transmitting the RRC message “UTRAN Mobility Information Confirm” to confirm the updated relevant information.

Similarly, FIG. 12 shows the URA update process without using the Iur interface according to the present invention, wherein:

1. the UE transmitting the RRC message—“URA Update”, which the CCCH bears, to the RNC to which the current resident cell belongs, i.e., the destination RNC, this message comprising an information element u-RNTI (UTRAN Radio Network Temporary Identifier), URA Update Cause and the like. This IE consists of the SRNC identifier SRNC-ID and the UE identifier s-RNTI (Serving Radio Network Temporary Identifier) allocated by the SRNC;

2. after receiving the RRC message, the destination RNC determining whether the Iur signalling link exists, wherein if exists, the URA update process will be performed with the signalling modes shown in FIG. 6 or 8 according to the prior art; otherwise, the following process will be preformed;

3. the destination RNC transmitting to the CN the RANAP message “Forward Uplink RRC Signalling”, wherein the SRNC-ID constitutes the information element “Source ID”, the known identifier of the destination RNC constitutes the information element “Target ID”, and the whole received RRC message “URA Update” directly serves as the information element “RRC Information”;

4. after receiving the RANAP message “Forward Uplink RRC Signalling” sent from the destination RNC, the CN, by using the information element “Source ID” carried by the above message, forwarding the received RANAP message directly to the SRNC without any processing;

5. after receiving the RANAP message “Forward Uplink RRC Signalling” sent from the CN, the SRNC extracting the RRC message “URA Update” from the information element “RRC Information” and initiating the SRNS relocation process without using the Iur interface by using the destination RNC indicated by the information element “Target ID”, namely, the SRNS relocation process for transmitting the SRNS context by using the RANAP message “Forward SRNS Context”;

6. wherein, when the SRNS relocation process reaches step 9 as shown in FIG. 9, the SRNS Context and the upper protocol entity of the UE have been switched to the destination RNC, and the destination RNC has become a new SRNC which consequently can send to the UE the RRC message “URA Update Confirm” which the CCCH (Common Control Channel) bears, this message containing the SRNC-ID of the destination RNC, i.e., the new SRNC, and the s-RNTI newly allocated by the new SRNC to the UE.

After receiving the RRC message “URA Update Confirm” sent from the new SRNC, the UE transmits the RRC message “UTRAN Mobility Information Confirm” to confirm the updated relevant information.

Moreover, according to the present invention, in the mobile system for the UE mobility management, the UE comprises means for transmitting uplink RRC signalling message to a first RNC so as to request the UE mobility management; a destination RNC comprises means for receiving from the UE and forwarding to the core network said uplink RRC signalling message; the core network comprises means for forwarding transparently to a serving RNC said uplink RRC signalling message; and the serving RNC comprises means for receiving and utilizing the forwarded uplink RRC signalling message to perform the requested mobility management. According to the method of the present invention and the disclosed contents of the present invention, the person skilled in the art can easily realize the above means.

Thus, the method for the UE mobility management according to the present invention, namely, the method for cell update and UTRAN routing area update when there is no Iur signalling link, has been described in detail. It should be understood that, for those skilled in the art, the above explanations are merely exemplary, and various modifications can be made according to the present invention and they are not divorced from the principles of the present invention.

1. A method for user equipments (UE) mobility management in a mobile communication system, wherein said mobile communication system comprises; a core network, one or more universal terrestrial radio access networks (UTRAN) and a plurality of user equipments (UE), wherein the core network communicates with the UTRAN via an Iu interface; said UTRAN consists of a plurality of radio network systems (RNS) and communicates with one or more UEs via a Uu interface, each said RNS comprising a radio network controller (RNC) and one or more nodes communicating with said RNC through an Iub interface, each node comprising one or more cells, and the communication between RNCs being performed via an Iur interface; the UTRAN controls the UE mobility management through a radio resource control (RRC) signaling of the Uu interface; said method comprising the steps of:
the UE transmitting uplink an RRC signaling message to a first RNC so as to request UE mobility management;
said first RNC receiving and forwarding to the core network said uplink RRC signaling message;
the core network forwarding transparently to a second RNC said uplink RRC signaling message; and
the second RNC receiving and utilizing the forwarded uplink RRC signaling message to perform the requested mobility management.

2. The method according to claim 1, characterized by further comprising a determining step for determining whether there exists Iur transport link between said first RNC and said second RNC, before the step in which the first RNC forwards said uplink RRC signaling message.

3. The method according to claim 1, characterized in that said first RNC is a destination RNC communicating with said UE; said second RNC is a serving RNC for controlling said UE and causing said UE to communicate with the core network.

4. The method according to claim 1, characterized in that in the step in which said first RNC forwards to the core network said uplink RRC signaling message, said uplink RRC signaling message as an RANAP signaling message is transmitted from said first RNC to said core network via the Iu interface, wherein said RANAP signaling message includes Message Type, Source ID, Target ID and RRC information relevant to the mobility management requested by the UE.

5. A method according to claim 4, characterized in that in said RANAP signaling message transmitted from the first RNC to the core network, Source ID identifies the second RNC, Target ID identifies the first RNC, and RRC information relevant to the mobility management requested by the UE is defined as cell update message or URA update message.

6. The method according to claim 1, characterized in that in the step in which the UE transmits uplink the RRC signaling message to the first RNC, said UE transmits via a Common Control Channel (CCCH) an RRC signaling message for requesting cell update.

7. The method according to claim 1, characterized in that in the step in which the UE transmits uplink the RRC signaling message to the first RNC, said UE transmits via the Common Control Channel (CCCH) an RRC signaling message for requesting URA update.

8. A mobile communication system for user equipments (UEs) mobility management, wherein said mobile communication system comprises; a core network, one or more universal terrestrial radio access networks (UTRANs) and a plurality of user equipments (UEs), wherein the core network communicates with the UTRAN via an Iu interface; said UTRAN consists of a plurality of radio network systems (RNSs) and communicates with one or more UEs via a Uu interface, each said RNS comprising a radio network controller (RNC) and one or more nodes communicating with said RNC through an Iub interface, each node comprising one or more cells, and the communication between RNCs being performed via an Iur interface; the UTRAN controls the UE mobility management through a radio resource control (RRC) signaling of the Uu interface; and wherein:
the UE comprises means for transmitting uplink the RRC signaling message to a first RNC so as to request the UE mobility management;
said first RNC comprises means for receiving from said UE and forwarding to the core network said uplink RRC signaling message;
the core network comprises means for forwarding transparently to a second RNC said uplink RRC signaling message; and
the second RNC comprises means for receiving and utilizing the forwarded uplink RRC signaling message to perform the requested mobility management.

9. The system according to claim 8, characterized in that said first RNC further comprises means for determining whether there exists Iur transport link between said first RNC and said second RNC.

10. The system according to claim 7, characterized in that said first RNC is a destination RNC communicating with said UE; said second RNC is a serving RNC for controlling said UE and causing said UE to communicate with the core network.

11. The system according to claim 7, characterized in that said first RNC forwards via the Iu interface to the core network said uplink RRC signaling message as an RANAP signaling message, wherein said RANAP signaling message includes Message Type, Source ID, Target ID and RRC information relevant to the mobility management requested by the UE.

12. The system according to claim 11, characterized in that in said RANAP signaling message forwarded by the first RNC to the core network, Source ID identifies the second RNC, Target ID identified the first RNC, and RRC information relevant to the mobility management requested by the UE is defined as cell update message or URA update message.

13. The system according to claim 7, characterized in that the UE transmitting uplink the RRC signaling message to the first RNC includes said UE transmitting uplink via a Common Control Channel an RRC signaling message for requesting cell update.

14. The system according to claim 7, characterized in that the UE transmitting uplink the RRC signaling message to the first RNC includes said UE transmitting uplink via the Common Control Channel an RRC signaling message for requesting URA update.

15. The system according to claim 8, characterized in that said first RNC is a destination RNC communicating with said UE; said second RNC is a serving RNC for controlling said UE and causing said UE to communicate with the core network.

16. The system according to claim 8, characterized in that said first RNC forwards via the Iu interface to the core network said uplink RRC signaling message as an RANAP signaling message, wherein said RANAP signaling message includes Message Type, Source ID, Target ID and RRC information relevant to the mobility management requested by the UE.

17. The system according to claim 8, characterized in that the UE transmitting uplink the RRC signaling message to the first RNC includes said UE transmitting uplink via a Common Control Channel an RRC signaling message for requesting cell update.

18. The system according to claim 8, characterized in that the UE transmitting uplink the RRC signaling message to the first RNC includes said UE transmitting uplink via the Common Control Channel an RRC signaling message for requesting URA update.

19. The method according to claim 2, characterized in that said first RNC is a destination RNC communicating with said UE; said second RNC is a serving RNC for controlling said UE and causing said UE to communicate with the core network.

20. The method according to claim 2, characterized in that in the step in which said first RNC forwards to the core network said uplink RRC signaling message, said uplink RRC signaling message as an RANAP signaling message is transmitted from said first RNC to said core network via the Iu interface, wherein said RANAP signaling message includes Message Type, Source ID, Target ID and RRC information relevant to the mobility management requested by the UE.
